(19) United States
(12) Patent Application Publication
(10) Pub. No.: US 2007/0074865 A1
(43) Pub. Date: Apr. 5, 2007

(54) Constant temperature liquid circulating deivce having external piping protecting function

(75) Inventors: Takeo Ichinose, Tsukubamirai-shi (JP); Katsutoshi Sato, Tsukubamirai-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SMC Corporation, Chiyoda-ku (JP)

(21) Appl. No.: 11/521,558

(22) Filed: Sep. 15, 2006

(30) Foreign Application Priority Data
Sep. 30, 2005 (JP) 2005-288601

(51) Int. Cl. F24F 11/04; G05D 23/00

(52) U.S. Cl. 165/247; 165/293

(57) ABSTRACT

In a constant temperature liquid circulating device having a conduit for delivering a temperature controlled constant temperature circulating liquid with a pump, which is used with an external device connected thereto, the pressure of the circulating liquid in a piping in the external device is controlled so as not to exceed a preset maximum pressure value to protect the piping in the external device. In a constant temperature liquid circulating device having a conduit for delivering constant temperature circulating liquid controlled in temperature and delivering the circulating liquid at a constant temperature to an external device, a control function is provided to the controller for controlling the operation of the constant temperature liquid circulating device so that the detected pressure does not exceed the preset maximum pressure on the basis of outputs from an arbitrary number of pressure sensors for detecting the pressure at a predicted pressure rising point of the piping in the external device.

### TECHNICAL FIELD

The present invention relates to a constant temperature liquid circulating device having a function to protect an external piping so that application of a pressure of circulating liquid to a piping to be installed in an external device that is connected to the constant temperature liquid circulating device (hereinafter referred to as external piping) by an amount exceeding a pressure tightness thereof is prevented.

### BACKGROUND ART

Hitherto, in a constant temperature liquid circulating device, it is known that the frequency of a pump is controlled by an inverter in order to control the flow amount of the constant temperature circulating liquid to a predetermined flow amount, for example, in Patent Document 1.

However, the control performed by monitoring only the flow amount in the related art has a problem such that if a resistance of the external piping is increased for any reason, the pressure in the piping is increased more than necessary, and hence sudden increase in pressure may occur, for example, when a valve remains closed unexpectedly, or when the external piping is broken or being stepped thereon by a foot or the like.

When the pressure in the external piping is brought into a high level, if the pressure tightness of the external piping is entirely or partly low, it may result in an accident such as explosion. Actually, the eternal piping itself is prepared by a user of the external device, and hence there may be a case in which a piping with low pressure tightness is used without considering the liquid delivery capability of the constant temperature liquid circulating device. Therefore, it is desired to provide the external piping protecting function to the constant temperature liquid circulating device itself.

Japanese Unexamined Patent Application Publication No. 9-325821

### DISCLOSURE OF THE INVENTION

The technical subject of the present invention is to provide a constant temperature liquid circulating device having a conduit for delivering circulating liquid controlled to a constant temperature with a pump in which both ends of the external piping are connected respectively to an inlet port and an outlet port of the conduit to form a circulating flow channel for allowing the circulating liquid to be circulated therein, wherein a function to monitor the pressure of the circulating liquid in the external piping and control the pressure thereof so as not to exceed a preset maximum pressure value is provided to achieve a high safety constant temperature liquid circulating device in which the external piping can be protected.

In order to solve the above-described problem, the present invention provides a constant temperature liquid circulating device having a conduit for delivering circulating liquid controlled to a constant temperature with a pump, in which both ends of the piping that defines a flow channel of the circulating liquid in an exterior device to be controlled in temperature by the circulating liquid are connected respectively to an inlet port and an outlet port of the conduit to form a circulating flow channel for allowing the circulating liquid to be circulated therein, characterized in that a control function to control the flow amount or the pressure of the circulating liquid to be delivered to the piping in the external device is provided to a controller for controlling the operation of the constant temperature liquid circulating device so that the detected pressure does not exceed the preset maximum pressure on the basis of outputs from an arbitrary number of pressure sensors provided in the circulating flow channel for detecting the pressure at a predicted pressure rising point of the piping in the external device.

In the preferred embodiment of the constant temperature liquid circulating device according to the present invention, a function to control the number of rotations of the pump by an inverter to control the pressure of the circulating liquid to be delivered to the circulating flow channel is provided to the controller as a control function to control the flow amount or the pressure of the circulating liquid.

Another preferred embodiment of the constant temperature liquid circulating device according to the present invention includes a bypass channel provided for communicating the outlet port and the inlet port of the conduit in the constant temperature liquid circulating device, and an electric valve provided in the bypass flow path for adjusting the flow amount of the liquid flowing therein, thereby controlling the flow amount of the circulating liquid flowing in the piping in the external device, wherein a function to control the flow amount of the liquid flowing in the bypass flow channel is provided by controlling the electric valve is provided to the controller as a control function to control the flow amount or the pressure of the circulating liquid.

The electric valve is preferably an electric three-direction valve provided at a branch point between the piping of the external device and the bypass flow channel at an outlet port of the conduit in the constant temperature liquid circulating device, and in this case, the pressure sensor is preferably provided on the exterior device side with respect to junction points with the bypass flow channel at the outlet port and the inlet port of the conduit of the constant temperature liquid circulating device.

According to another preferred embodiment of the constant temperature liquid circulating device in the present invention includes an electric proportional valve at the outlet port of the conduit in the constant temperature liquid circulating device for controlling the flow amount of the circulating liquid flowing therethrough into the piping of the external device so that a function to control the flow amount of the liquid flowing in the piping in the external device by controlling the electric proportional valve is provided to the controller as a control function to control the flow amount or the pressure of the circulating liquid.

In this case, the pressure sensor is preferably provided on the downstream side of the electric proportional valve before reaching a temperature controlling portion of the constant temperature liquid circulating device.

According to the constant temperature liquid circulating device having an external piping protecting function in the present invention configured as described above, the controller controls the pressure in the external piping so as not to exceed the preset maximum value by supplying the preset maximum pressure value according to the pressure tightness of the external piping to the controller. Therefore, the constant temperature circulating liquid which is controlled so as not to exceed the pressure tightness of the external piping that the user of the external device connects is delivered, whereby the external piping is protected.

According to the constant temperature liquid circulating device having the external piping protecting function in the present invention described above in detail, there is provided the constant temperature liquid circulating device including the conduit for delivering the circulating liquid controlled to the constant temperature by the pump, in which the both ends of the external piping are connected respectively to the inlet port and the outlet port of the conduit to form the circulating flow channel for allowing the circulating liquid to be circulated therein, wherein the pressure of the circulating liquid in the external piping is monitored and controlled so as not to exceed the preset maximum pressure value. Therefore, a high safety constant temperature liquid circulating device which can protect the external piping can be provided.

### BRIEF DESCRIPTION OF THE DRAWINGS

FIG. 1 is a block diagram showing a first embodiment of a constant temperature liquid circulating device according to the present invention.

FIG. 2 is a block diagram showing a second embodiment of the same.

FIG. 3 is a block diagram showing a third embodiment of the same.

### BEST MODE FOR CARRYING OUT THE INVENTION

Referring now to the drawings, embodiments of the present invention will be described in detail.

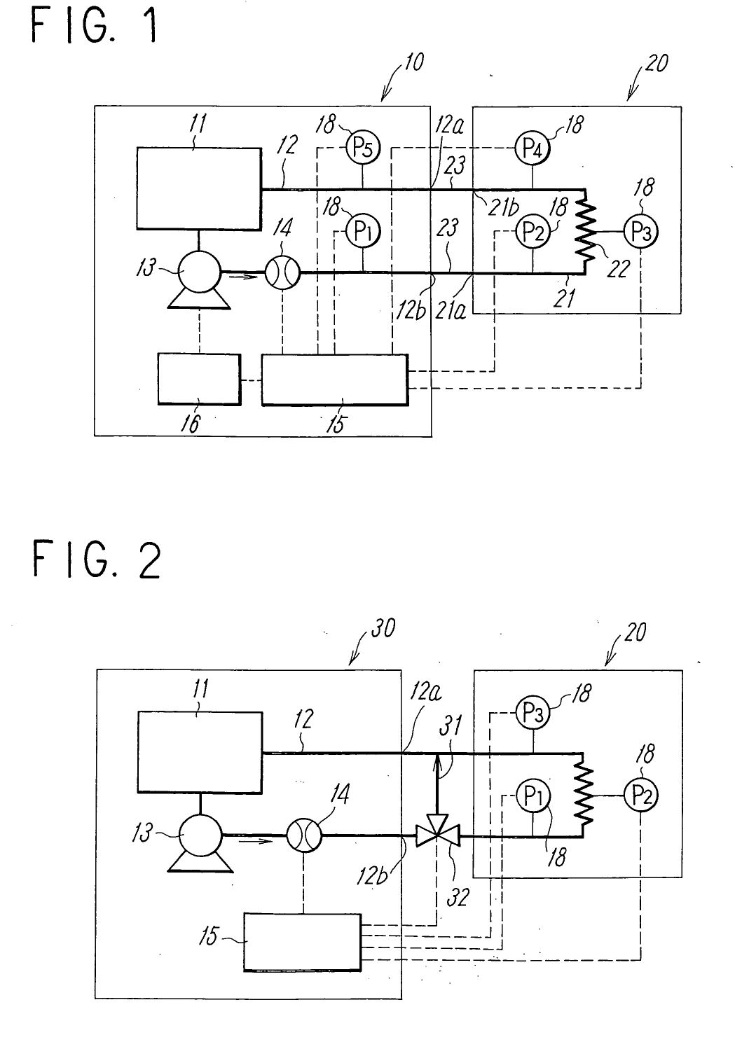

FIG. 1 shows a first embodiment of a constant temperature liquid circulating device according to the present invention. A constant temperature liquid circulating device 10 includes a tank 11 for storing circulating liquid controlled to a constant temperature by a heat exchanger, a conduit 12 having an inlet port 12a and an outlet port 12b for allowing the constant temperature liquid in the tank to circulate through an external device 20, a pump 13 provided in the conduit 12 for delivering the constant temperature circulating liquid in the tank 11 to the external device 20, and a flow amount sensor 14 provided in the vicinity of the outlet port 12b of the conduit 12.

Means for controlling the temperature of the circulating liquid stored in the tank 11 is not specifically limited, and in the case of cooling, for example, there is a water-cooled system, a system using a freezing Pertier device and so on, and in the case of heating, there is a heater system, a hot gas system and so on.

On the other hand, the external device 20 connected to the constant temperature liquid circulating device 10 and controlled in temperature by the circulating liquid forms a circulating flow channel for allowing the circulating liquid to be circulated therein in cooperation with the conduit 12 in the constant temperature liquid circulating device 10 by connecting the both ends of a piping 21 that defines the flow channel of the circulating liquid in the external device 20, that is, the outlet port end 21b and the inlet port end 21a respectively to the inlet port 12a and the outlet port 12b of the conduit 12 in the constant temperature liquid circulating device 10, and a heat giving-receiving area 22 for giving and receiving the heat load to/from the object to be controlled in temperature is arranged at a midsection of the piping 21.

Connecting tubes 23 are connected between the inlet port 12a and the outlet port 12b of the conduit 12 in the constant temperature liquid circulating device 10 and the outlet port end 21b and the inlet port end 21a of the piping 21 of the external device 20 as needed.

The constant temperature liquid circulating device 10 is provided with a controller 15 for controlling the operation thereof The controller 15 is configured in such a manner that the user of the external device 20 can set the preset maximum pressure value according to the pressure tightness of the piping 21 in advance when connecting the external device 20 to the constant temperature liquid circulating device 10, and is provided with a control function to control the flow amount or the pressure of the circulating liquid to be delivered to the piping 21 of the external device so as to prevent the pressure in the piping 21 from exceeding the preset maximum pressure value preset to the controller 15 on the basis of the output from a pressure sensor 18 provided in the circulating flow channel. More specifically, the number of rotations of the pump 13 is controlled by an inverter 16 so that the flow amount detected by the flow amount sensor 14 falls within a range that does not exceed the preset maximum pressure value which is preset to the controller 15, whereby the pressure of the circulating liquid to be delivered to the circulating flow channel from the pump 13 is controlled.

An arbitrary number of pressure sensors 18 may be provided at required positions in the conduit 12 in the constant temperature liquid circulating device 10 and the piping 21 of the external device 20 for detecting the pressures at predicted pressure rising points of the piping 21 in the external device 20. For example, when setting the pressure to be delivered to the piping 21 in the external device from the inlet port end 21a thereof to a certain value or below is desired, the pressure sensor 18 may be provided in the vicinity of the outlet port 12b of the conduit 12 in the constant temperature liquid circulating device 10 (P₁ in the drawing), and when the resistance in the piping 21 is increased from any reason and hence restraint of abrupt rising in pressure in the piping 21 is desired, they may be provided at positions being subject to increase in pressure, or positions where increase in pressure is desired to be avoided as much as possible (P₂-P₅ in the drawing, for example).

When a plurality of the pressure sensors 18 is provided, the pressures can be detected at a plurality of points. Therefore, an abrupt pressure increase which may occur at any portion of the external device 20 can be detected immediately, and hence the response of the pressure control can be improved. The controller 15 can be configured in such a manner that a plurality of the preset maximum pressure values can be entered corresponding to the plurality of pressure sensors 18.

According to the constant temperature liquid circulating device having the external piping protecting function having the configuration described above, the pressure sensors 18 are installed in the circulating flow channel for monitoring the pressure information in the piping 21 of the external device 20 constantly by the controller 15, and the pressure in the piping 21 of the external device is controlled by the controller 15 so as not to exceed the preset maximum value according to the pressure tightness of the piping 21, which is entered by the user of the external device 20, whereby the constant temperature circulating liquid is delivered to prevent the pressure in the piping 21 from exceeding the pressure tightness of the external piping that is connected by the user of the external device 20, thereby protecting the piping 21.

Referring now to FIG. 2, a second embodiment of the constant temperature liquid circulating device according to the present invention will be described.

In the first embodiment, the number of rotations of the pump 13 is controlled by the inverter 16 for providing the controller 15 with the controlling function to control the flow amount or the pressure of the circulating liquid to be delivered to the piping 21 of the external device 20. Instead, a constant temperature liquid circulating device 30 in the second embodiment includes a bypass flow channel 31 for communicating the outlet port 12b and the inlet port 12a of the conduit 12 in the constant temperature liquid circulating device 30, and an electric valve 32 for controlling the flow amount of the circulating liquid flowing in the piping 21 in the external device 20 by adjusting the flow amount of the liquid flowing therein, thereby controlling the pressure in the piping 21 consequently.

The electric valve 32 may be an electric three-direction valve that can control the flow toward the piping 21 side and the flow toward the bypass flow channel 31 side in a no phased manner or in a step-by-step manner when it is provided at a branch point between the piping 21 of the external device 20 and the bypass flow channel 31 at the outlet port 12b of the conduit 12 in the constant temperature liquid circulating device 30 as shown in the drawing. It is also possible not to employ the configuration of the electric three-direction valve, and one or more electric valves 32 that can control the flow toward the piping 21 side and the flow toward the bypass flow channel 31 side may be provided on the piping 21 side or the bypass flow channel 31 side.

In the case of the second embodiment, if the pressure sensor 18 detects that the pressure in the piping 21 of the external device 20 is increased, the controller 15 can control the electric valve 32 so as to increase the flow amount to the bypass flow channel 31 on the basis of the output of the pressure sensor 18 to reduce the pressure in the piping 21.

When such an electric valve 32 is provided, the pressure sensor 18 is preferably provided on the external device 20 side with respect to the junction points with the bypass flow channel 31 at the outlet port 12b and the inlet port 12a of the conduit 12 of the constant temperature liquid circulating device 30. The position to provide the pressure sensor 18 may be determined according to the description given in conjunction with the first embodiment.

Since other configurations and effects in the second embodiment are substantially the same as those of the first embodiment, the same or corresponding portion in the drawing are designated by the same reference numerals and description thereof are omitted.

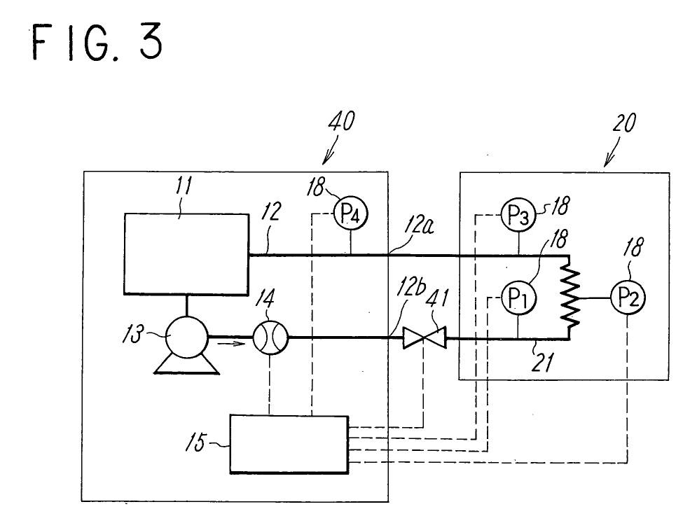

Referring now to FIG. 3, a third embodiment of the present invention will be described.

A constant temperature liquid circulating device 40 in the third embodiment includes an electric proportional valve 41 at the outlet port 12b of the conduit 12 of the constant temperature liquid circulating device 40 for controlling the flow amount of the circulating liquid flowing in the piping 21 of the external device 20 instead of the bypass flow channel 31 and the electric valve 32 in the second embodiment, and the electric proportional valve 41 is controlled by the controller 15 on the basis of the outputs from the pressure sensor 18 to control the flow amount of the liquid flowing in the piping 21 of the external device 20, so that when the pressure on the downstream side of the electric proportional valve 41 is increased, the electric proportional valve 41 is narrowed to lower the pressure.

The pressure sensor 18 in the third embodiment may be provided on the downstream side of the electric proportional valve 41 before reaching the temperature controlling portion (tank 11) in the constant temperature liquid circulating device 40. The position to install the pressure sensor 18 may be determined according to the description given in conjunction with the first embodiment.

Since other configurations and effects in the third embodiment are substantially the same as those in the first embodiment, the same or the corresponding portion in the drawing are designated by the same reference numerals and description thereof are omitted.

1. A constant temperature liquid circulating device having a conduit for delivering circulating liquid controlled to a constant temperature with a pump, in which both ends of the piping that defines a flow channel of the circulating liquid in an exterior device to be controlled in temperature by the circulating liquid are connected respectively to an inlet port and a outlet port to form a circulating flow channel for allowing the circulating liquid to be circulated therein,
characterized in that a controller for controlling the operation of the constant temperature liquid circulating device has a control function to control the flow amount or the pressure of the circulating liquid to be delivered to the piping in the external device so that the detected pressure does not exceed the preset maximum pressure on the basis of outputs from an arbitrary number of pressure sensors provided in the circulating flow channel for detecting the pressure at a predicted pressure rising point of the piping in the external device.

2. The constant temperature liquid circulating device according to claim 1, characterized in that the controller is constructed so as to control the number of rotations of the pump by an inverter to control the pressure of the circulating liquid to be delivered to the circulating flow channel.

3. The constant temperature liquid circulating device according to claim 1 comprising:
a bypass flow channel provided for communicating the outlet port and the inlet port of the conduit in the constant temperature liquid circulating device, and
an electric valve provided in the bypass flow channel for adjusting the flow amount of the liquid flowing therein, thereby controlling the flow amount of the circulating liquid flowing in the piping in the external device,
characterized in that the controller is constructed so as to control the flow amount of the liquid flowing in the bypass flow channel is provided by controlling the electric valve.

4. The constant temperature liquid circulating device according to claim 3, characterized in that the electric valve is an electric three-direction valve provided at a branch point between the piping of the external device and the bypass flow channel at an outlet port of the conduit in the constant temperature liquid circulating device.

5. The constant temperature liquid circulating device according to claim 4, characterized in that the pressure sensor is provided on the exterior device side with respect to junction points with the bypass flow channel at the outlet port and the inlet port of the conduit of the constant temperature liquid circulating device.

6. The constant temperature liquid circulating device according to claim 1 comprising an electric proportional valve at the outlet port of the conduit the constant temperature liquid circulating device for controlling the flow amount of the circulating liquid flowing therethrough into the piping of the external device,
characterized in that a function to control the flow amount of the liquid flowing in the piping in the external device by controlling the electric proportional valve is provide to the controller as a control function to control the flowing amount or the pressure of the circulating liquid.

7. The constant temperature liquid circulating device according to claim 6, characterized in that the pressure sensor is provided on the downstream side of the electric proportional valve before reaching the temperature controlling portion of the constant temperature liquid circulating device.
